(19) United States
(12) Patent Application Publication
(10) Pub. No.: US 2020/0393093 A1
(43) Pub. Date: Dec. 17, 2020

(54) NOVEL STADIUM LIGHT

(71) Applicant: XIAMEN JOINT TECH. CO.,LTD., Xiamen (CN)

(72) Inventors: Junshan Wang, Jinjiang (CN); Rongmimg Li, Zhangzhou (CN); Hongqiao Su, Xiamen (CN); Liping Chen, Xiamen (CN)

(21) Appl. No.: 17/005,342

(22) Filed: Aug. 28, 2020

(51) Int. Cl. F21S 2/00; F21V 29/70; F21V 21/26; F21V 31/00; F21V 17/12

(52) U.S. Cl. CPC F21S 2/005; F21V 29/70; F21V 17/12; F21V 31/005; F21V 21/26

(57) ABSTRACT

The present invention belongs to the technical field of a stadium light, in particular to a novel stadium light, including a light panel mounting plate and a plurality of light panel modules mounted on the light panel mounting panel. The light panel mounting plate is provided with a heat dissipation plate at one side thereof being far away from the light panel module. The heat dissipation plate is fixedly connected with the light panel mounting plate. The other side of the heat dissipation plate is fixedly mounted with a power supply mechanism for supplying power to the light panel module.

### TECHNICAL FIELD

The invention belongs to the technical field of a stadium light, and specifically relates to a novel stadium light.

### TECHNICAL BACKGROUND

An LED (Light-Emitting Diode) light is a lighting fixture made of the fourth-generation green light source LED. The LED is called as the fourth-generation lighting source or green light source. The LED has the characteristics of energy saving, environmental protection, a long service life and a small size and is widely used in various fields such as indication, display, decoration, backlight, general lighting and an urban night scene. An LED lighting application in the past were mainly for architectural landscape lighting, such as a garden street light, a searchlight, a step light, a balcony light, a stadium light, etc.

A lighting component, a housing and a power supply of the original stadium light are structures that are generally integrated and fixedly connected. The lighting panel in the prior art is not easy to disassemble and replace. If a part of the light beads are damaged, the entire panel needs to be replaced. Therefore, the high cost of the replacement or low replacement frequency affects the lighting effect, and the light panel in the prior art cannot be combined at will to change the shape of the light.

### SUMMARY

In order to solve the above-mentioned problems in the technical background, the present invention provides a novel stadium light, which is convenient for disassembly and replacement and changing the shape of a light.

In order to achieve the above object, the present invention provides the following technical solution: a novel stadium light comprises a light panel mounting plate and a plurality of light panel modules mounted on the light panel mounting plate, wherein the light panel mounting plate is provided with a heat dissipation plate at one side thereof being far away from the light panel module. The heat dissipation plate is fixedly connected with the light panel mounting plate. The other side of the heat dissipation plate is fixedly mounted with a power supply mechanism for supplying power to the light panel module. The power supply mechanism is fixedly connected with the heat dissipation plate. A bracket is mounted on the outer side of the power supply mechanism. An adjustment mechanism is provided at the connection between the bracket and the power supply mechanism. The bracket is fixedly connected with the power supply mechanism via the adjustment mechanism. The light panel module comprises an arc-shaped panel and a rectangular panel, the arc-shaped panel and/or the rectangular panel can be detachably mounted on the light panel mounting plate. The light panel module comprises a light bead mounting plate, a PCB panel and a light bead. There is a plurality of light beads which are fixedly mounted on the light bead mounting plate. The PCB panel is covered on the surface of the light bead mounting plate. The edge of the PCB panel is hermetically connected with the light bead mounting plate, and the plurality of light beads are located between the light bead mounting plate and the PCB panel.

Preferably, the edge of the light bead mounting plate is provided with a rectangular slot and a rectangular boss that are staggered, and the rectangular slot and the rectangular boss that are located between the two adjacent light bead mounting plates cooperate with each other.

Preferably, the edge corner of the light bead mounting plate is provided with an arc-shaped boss or an arc-shaped slot, and the arc-shaped boss and the arc-shaped slot that are located between the two adjacent light bead mounting plates cooperate with each other.

Preferably, a sealing strip is provided at the connection between the light bead mounting plate and the PCB panel. The sealing strip is fixedly connected with the light bead mounting plate, and the light bead mounting plate is hermetically connected with the PCB panel via the sealing strip. Preferably, a plurality of screws is provided at the edge of the light bead mounting plate, and the screw penetrates the PCB panel and is screwed and fixed with the light bead mounting plate. Preferably, the top of the front side of the light panel mounting plate is provided with a flashing plate, and the flashing plate is fixedly connected with the light panel mounting plate.

Preferably, the power supply mechanism comprises a mounting box and a power supply assembly. The mounting box is fixedly mounted on the surface of the heat dissipation plate. The power supply assembly is fixedly mounted inside the mounting box, and the outer wall of the mounting box is opened and provided with a heat dissipation window for heat dissipation. Preferably, the adjustment mechanism comprises a hand rocker and a ratchet mechanism. The ratchet mechanism is located on the inner side of the bracket. The hand rocker is rotatably mounted on the outer side of the bracket, and the hand rocker is hinged with the ratchet mechanism.

Preferably, the light panel module is fixedly mounted on the light panel mounting plate via a screwing way.

Preferably, the flashing plate is covered on the upper half of the light panel mounting plate. Compared with the prior art, the present invention has the following beneficial effects:

In the present invention, the light panel module is modularly designed and arranged as an arc-shaped panel and a rectangular panel. The arc-shaped panel is a ¼-semicircle, the rectangular panel is a square whose side length is the same as the radius of the arc-shaped panel. The rectangular panel can be freely combined with the arc-shaped panel to form a variety of shapes. Therefore, the contour of the light can have various shapes, and the light panel modules can also be interchangeable. When a part of the light panel module of a light is damaged, it is convenient to disassemble and replace the part, thus reducing the cost of replacement and the cost of replacing parts and components.

### BRIEF DESCRIPTION OF THE DRAWINGS

The accompanying drawings are used to provide a further understanding of the present invention, constitute a part of the specification, are used to explain the present invention together with the embodiments of the present invention, and do not constitute a limitation to the present invention.

In the drawings:

FIG. 1 is a structural diagram of the present invention;

FIG. 2 is a structural side diagram of the present invention;

FIG. 3 is a structural diagram of an arc-shaped panel of the present invention;

FIG. 4 is a structural diagram of a rectangular panel of the present invention;

FIG. 5 is a diagram of a three-dimensional structure of the present invention;

FIG. 6 is a structural diagram of an embodiment of the present invention;

FIG. 7 is a structural diagram of another embodiment of the present invention;

FIG. 8 is a structural diagram of another embodiment of the present invention.

In the drawings: 1. Light Panel Mounting Plate; 11. Flashing Plate; 2. Light Panel Module; 2a. Arc-Shaped Panel; 2b. Rectangular Panel; 201. Rectangular Slot; 202. Arc-Shaped Boss; 203. Arc-Shaped Slot; 204. Rectangular Boss; 21. Light Bead Mounting Plate; 211. Sealing Strip; 212. Screw; 22. PCB Panel; 23. Light Bead; 3. Bracket; 4. Adjustment Mechanism; 41. Hand Rocker; 42. Ratchet Mechanism; 5. Power Supply Mechanism; 51. Mounting Box; 511. Heat Dissipation Window; 52. Power Supply Assembly; 6. Heat Dissipation Plate.

### DETAILED DESCRIPTION

The technical solutions in the embodiments of the present invention will be clearly and completely described below in conjunction with the accompanying drawings in the embodiments of the present invention. Obviously, the described embodiments are only a part of the embodiments of the present invention, rather than all the embodiments. Based on the embodiments of the present invention, all other embodiments obtained by the person skilled in the art without creative work shall fall within the protection scope of the present invention.

### Embodiment 1

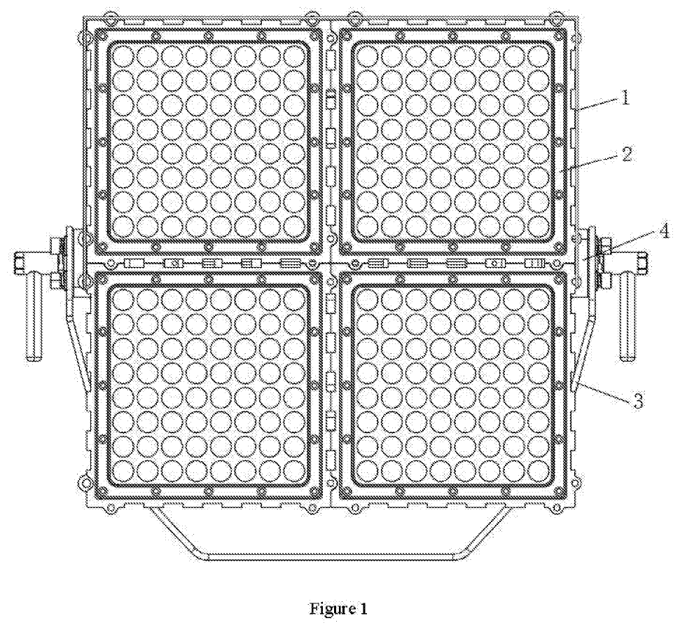

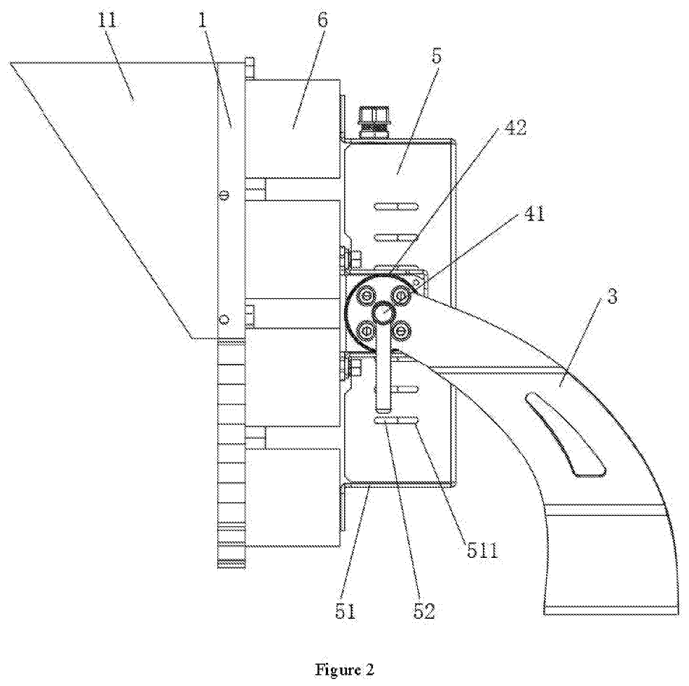

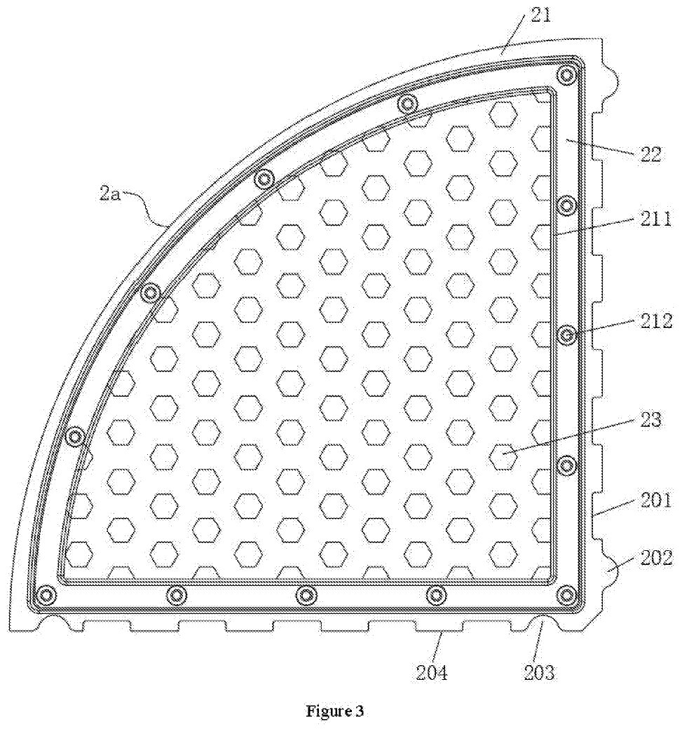

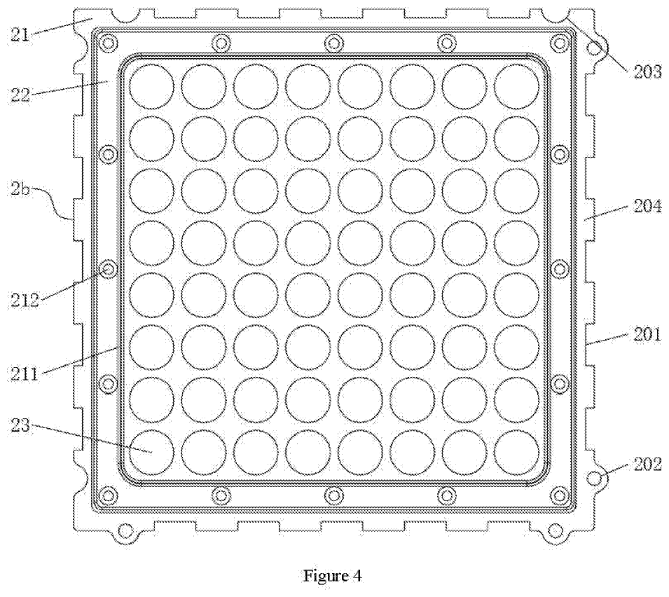

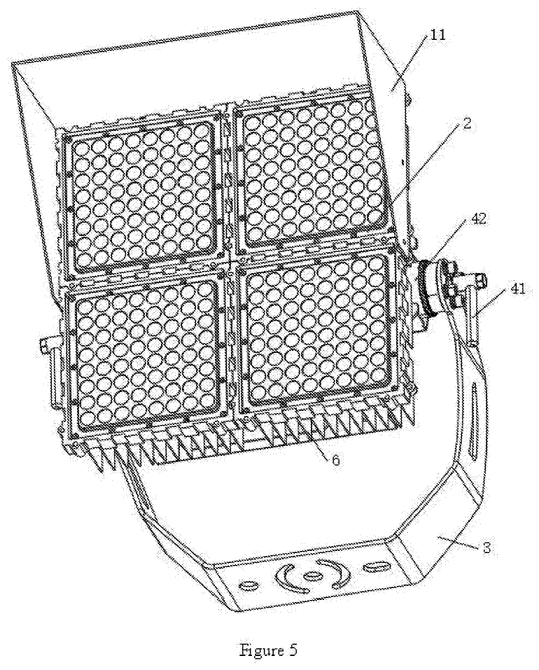

Please refer to FIGS. 1-5, the present invention provides the following technical solution: a novel stadium light comprises a light panel mounting plate 1 and a plurality of light panel modules 2 mounted on the light panel mounting plate 1, wherein the light panel mounting plate 1 is provided with a heat dissipation plate 6 on one side thereof being far away from the light panel module 2. The heat dissipation plate 6 is fixedly connected with the light panel mounting plate 1. The other side of the heat dissipation plate 6 is fixedly mounted with a power supply mechanism 5 for supplying power to the light panel module 2. The power supply mechanism 5 is fixedly connected with the heat dissipation plate 6. The outer side of the power supply mechanism 5 is mounted with a bracket 3. An adjustment mechanism 4 is provided at the connection between the bracket 3 and the power supply mechanism 5. The bracket 3 is fixedly connected with the power supply mechanism 5 via the adjustment mechanism 4. The light panel module 2 comprises an arc-shaped panel 2a and a rectangular panel 2b. The arc-shaped panel 2a and/or the rectangular panel 2b can be detachably mounted on the light panel mounting plate 1. The light panel module 2 comprises a light bead mounting plate 21, a PCB panel 22 and a light bead 23. There is the plurality of light beads 23 which are fixedly mounted on the light bead mounting plate 21. The PCB panel 22 is covered on the surface of the light bead mounting plate 21. The edge of the PCB panel 22 is hermetically connected with the light bead mounting plate 21. The plurality of light beads 23 are located between the light bead mounting plate 21 and the PCB panel 22.

In this embodiment, the light panel module 2 comprises the arc-shaped panel 2a and the rectangular panel 2b. The arc-shaped panel 2a and/or the rectangular panel 2b can be detachably mounted on the light panel mounting plate 1. The light panel module 2 is modularly designed and arranged as the arc-shaped panel 2a and the rectangular panel 2b. The arc-shaped panel 2a is a ¼-semicircle, the rectangular panel 2b is a square whose side length is the same as the radius of the arc-shaped panel 2a. The rectangular panel 2b can be freely combined with the arc-shaped panel 2a to form a variety of shapes. Therefore, the contour of the light can have various shapes, and the light panel modules 2 can also be interchangeable. When a part of the light panel module 2 of a light is damaged, it is convenient to disassemble and replace the part, thus reducing the cost of replacement and the cost of replacing parts and components.

Specifically, the edge of the light bead mounting plate 21 is provided with a rectangular slot 201 and a rectangular boss 204 that are staggered. The rectangular slot 201 and the rectangular boss 204 that are located between the two adjacent light bead mounting plates 21 cooperate with each other. The edge corners of the light bead mounting plate 21 are provided with an arc-shaped boss 202 or an arc-shaped slot 203. The arc-shaped boss 202 and the arc-shaped slot 203 that are located between the two adjacent light bead mounting plates 21 cooperate with each other. The rectangular slot 201, the rectangular boss 204, the arc-shaped boss 202 and the arc-shaped slot 203 are provided on the edge of the light bead mounting plate 21, and can be used for mutual cooperation between the light panel modules 2 to make the installation more stable and have high degree of adaptation.

Specifically, a sealing strip 211 is provided at the connection between the light bead mounting plate 21 and the PCB panel 22. The sealing strip 211 is fixedly connected with the light bead mounting plate 21. The light bead mounting plate 21 is hermetically connected with the PCB panel 22 via the sealing strip 211. A plurality of screws 212 is provided at the edge of the light bead mounting plate 21. The screw 212 penetrates the PCB panel 22 and is screwed and fixed with the light bead mounting plate 21. By setting the sealing strip 211, the airtightness between the light bead mounting plate 21 and the PCB panel 22 can be enlarged to ensure the electrical stability of the inner light beads 23 and avoid moisture.

Specifically, a flashing plate 11 is provided on the top of the front side of the light panel mounting plate 1. The flashing plate 11 is fixedly connected with the light panel mounting plate 1. By setting the flashing plate 11, direct rain can be avoided.

Specifically, the power supply mechanism 5 comprises a mounting box 51 and a power supply assembly 52. The mounting box 51 is fixedly mounted on the surface of the heat dissipation plate 6. The power supply assembly 52 is fixedly mounted inside the mounting box 51. The outer wall of the mounting box 51 is opened and provided with a heat dissipation window 511 for heat dissipation. When being in use, the power supply assembly 52 supplies power to the light bead 23 to convert city power into direct current which the light bead 23 can directly use.

Specifically, the adjustment mechanism 4 comprises a hand rocker 41 and a ratchet mechanism 42. The ratchet mechanism 42 is located on the inner side of the bracket 3. The hand rocker 41 is rotatably mounted on the outer side of the bracket 3. The hand rocker 41 is hinged with the ratchet mechanism 42. By setting the adjustment mechanism 4, the angle of the ratchet mechanism 42 can be adjusted by rotating the hand rocker 41, thereby adjusting the illumination angle and range of the light.

Specifically, the light panel module 2 is fixedly mounted on the light panel mounting plate 1 by a screwing way, which is convenient for disassembly.

Specifically, the flashing plate 11 is covered on the upper half of the light panel mounting plate 1 to avoid direct rain.

### Embodiment 2

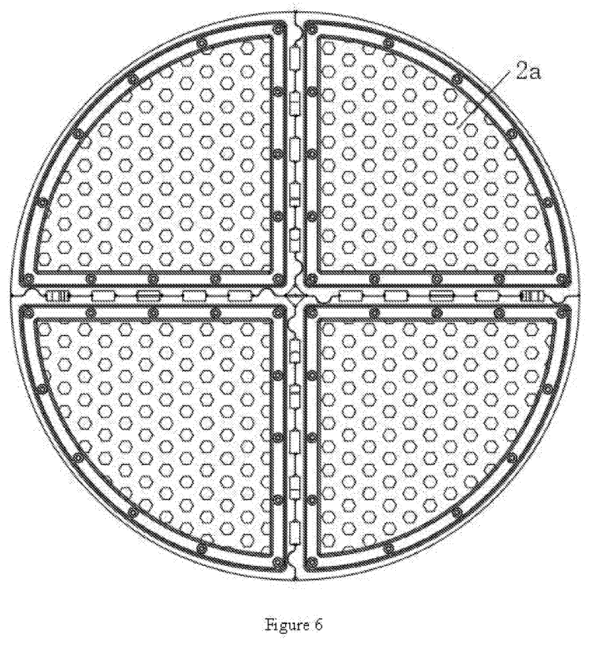

As shown in FIG. 6, four arc-shaped panels 2a can be spliced to form a circular light panel module 2, which has a relatively small volume and is suitable for small-scale lighting.

### Embodiment 3

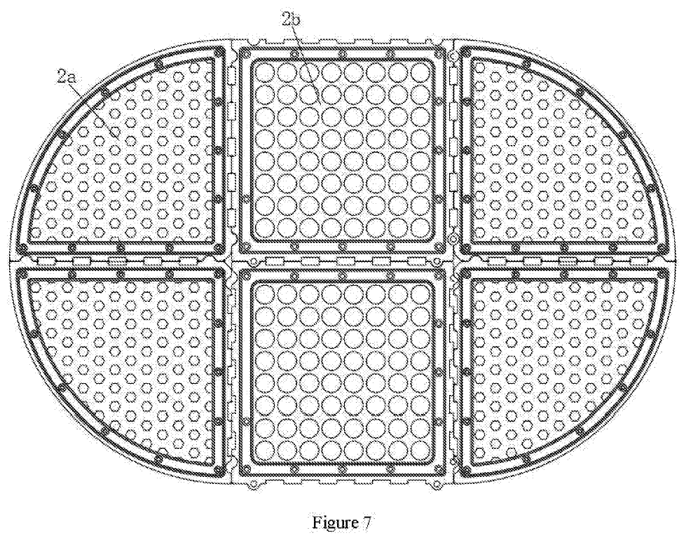

As shown in FIG. 7, two rectangular panels 2b can be spliced in the middle of four arc-shaped panels 2a to form an elliptical light panel module 2, which is relatively medium in volume and suitable for medium-range lighting.

### Embodiment 4

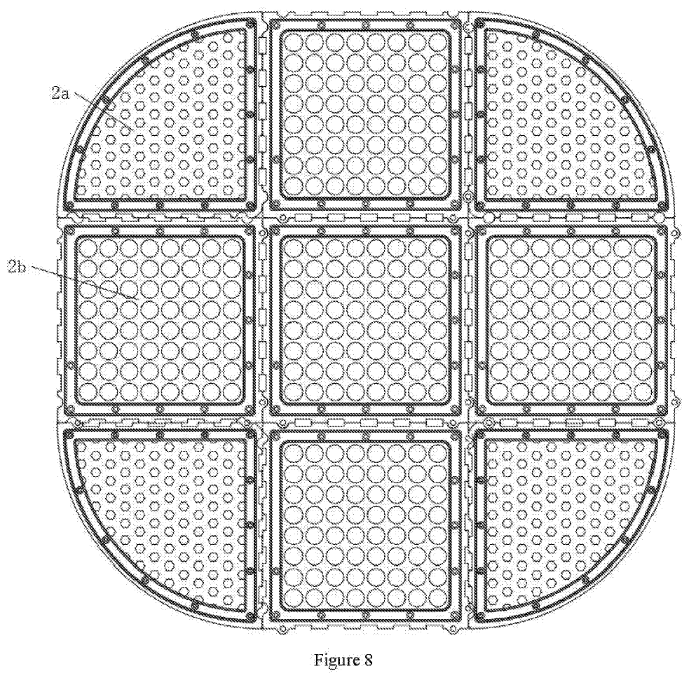

As shown in FIG. 8, five rectangular panels 2b can be spliced in the middle of four arc-shaped panels 2a to form a rectangular light panel module 2 with rounded corners, which is relatively large in volume and suitable for a wide range of lighting.

Finally, it should be noted that the above descriptions are only preferred embodiments of the present invention and are not intended to limit the present invention. Although the present invention has been described in detail with reference to the foregoing embodiments, the person skilled in the art may still modify the technical solutions described in the foregoing embodiments, or equivalently replace a part of the technical features. Any modification, equivalent replacement, improvement, etc., made within the spirit and principle of the present invention shall be comprised in the protection scope of the present invention.

1. A novel stadium light, comprising a light panel mounting plate (1) and a plurality of light panel modules (2) mounted on the light panel mounting plate (1), wherein the light panel mounting plate (1) is provided with a heat dissipation plate (6) at one side thereof being far away from the light panel module (2), the heat dissipation plate (6) is fixedly connected with the light panel mounting plate (1), the other side of the heat dissipation plate (6) is fixedly mounted with a power supply mechanism (5) for supplying power to the light panel module (2), the power supply mechanism (5) is fixedly connected with the heat dissipation plate (6), a bracket (3) is mounted on the outer side of the power supply mechanism (5), an adjustment mechanism (4) is provided at the connection between the bracket (3) and the power supply mechanism (5), the bracket (3) is fixedly connected with the power supply mechanism (5) via the adjustment mechanism (4), the light panel module (2) comprises an arc-shaped panel (2a) and a rectangular panel (2b), the arc-shaped panel (2a) and/or the rectangular panel (2b) can be detachably mounted on the light panel mounting plate (1), the light panel module (2) comprises a light bead mounting plate (21), a PCB panel (22) and a light bead (23), there is a plurality of light beads (23) which are fixedly mounted on the light bead mounting plate (21), the PCB panel (22) is covered on the surface of the light bead mounting plate (21), the edge of the PCB panel (22) is hermetically connected with the light bead mounting plate (21), and the plurality of light beads (23) are located between the light bead mounting plate (21) and the PCB panel (22).

2. The novel stadium light according to claim 1, wherein the edge of the light bead mounting plate (21) is provided with a rectangular slot (201) and a rectangular boss (204) that are staggered, and the rectangular slot (201) and the rectangular boss (204) that are located between the two adjacent light bead mounting plates (21) cooperate with each other.

3. The novel stadium light according to claim 1, wherein the edge corner of the light bead mounting plate (21) is provided with an arc-shaped boss (202) or an arc-shaped slot (203), and the arc-shaped boss (202) and the arc-shaped slot (203) that are located between the two adjacent light bead mounting plates (21) cooperate with each other.

4. The novel stadium light according to claim 1, wherein a sealing strip (211) is provided at the connection between the light bead mounting plate (21) and the PCB panel (22), the sealing strip (211) is fixedly connected with the light bead mounting plate (21), and the light bead mounting plate (21) is hermetically connected with the PCB panel (22) via the sealing strip (211).

5. The novel stadium light according to claim 1, wherein a plurality of screws (212) is provided at the edge of the light bead mounting plate (21), and the screw (212) penetrates the PCB panel (22) and is screwed and fixed with the light bead mounting plate (21).

6. The novel stadium light according to claim 1, wherein the top of the front side of the light panel mounting plate (1) is provided with a flashing plate (11), and the flashing plate (11) is fixedly connected with the light panel mounting plate (1).

7. The novel stadium light according to claim 1, wherein the power supply mechanism (5) comprises a mounting box (51) and a power supply assembly (52), the mounting box (51) is fixedly mounted on the surface of the heat dissipation plate (6), the power supply assembly (52) is fixedly mounted inside the mounting box (51), and the outer wall of the mounting box (51) is opened and provided with a heat dissipation window (511) for heat dissipation.

8. The novel stadium light according to claim 1, wherein the adjustment mechanism (4) comprises a hand rocker (41) and a ratchet mechanism (42), the ratchet mechanism (42) is located on the inner side of the bracket (3), the hand rocker (41) is rotatably mounted on the outer side of the bracket (3), and the hand rocker (41) is hinged with the ratchet mechanism (42).

9. The novel stadium light according to claim 1, wherein the light panel module (2) is fixedly mounted on the light panel mounting plate (1) via a screwing way.

10. The novel stadium light according to claim 6, wherein the flashing plate (11) is covered on the upper half of the light panel mounting plate (1).
